(19) United States
(12) Patent Application Publication
(10) Pub. No.: US 2026/0166788 A1
(43) Pub. Date: Jun. 18, 2026

(54) Molding device for manufacturing a sanitary tub formed as a casting foam component, method for manufacturing such a sanitary tub, and sanitary tub

(71) Applicant: Peter Mechtold, Rödental (DE)

(72) Inventor: Peter Mechtold, Rödental (DE)

(21) Appl. No.: 19/421,531

(22) Filed: Dec. 16, 2025

(30) Foreign Application Priority Data
Dec. 16, 2024 (DE) 102024137969.3

(51) Int. Cl. B29C 44/58; A47K 3/02; A47K 3/40; B29C 44/02; B29C 44/06; B29K 75/00; B29L 31/00

(52) U.S. Cl. CPC B29C 44/583; A47K 3/02; A47K 3/40; B29C 44/02; B29C 44/06; B29C 44/588; B29K 2075/00; B29L 2031/769

(57) ABSTRACT

The present invention relates to a molding device for manufacturing a sanitary tub formed as a three-dimensionally molded casting foam component, having a cavity forming a negative mold of the sanitary tub, comprising a plurality of molding parts that can be connected to one another to close the molding device and that, in a connected state, form the cavity, wherein at least one accessory part of the finished sanitary tub and/or at least one placeholder for at least one accessory part that is subsequently installable in the finished sanitary tub can be attached to at least one of the molding parts. The present invention further relates to a method for manufacturing such a sanitary tub as well as to a sanitary tub.

### FIELD OF THE INVENTION

This application claims the benefit of German Patent Application No. DE 102024137969.3, filed on Dec. 16, 2024, the content of which is incorporated herein by reference in its entirety.

### FIELD OF THE INVENTION

The present invention relates to a molding device for manufacturing a sanitary tub formed as a three-dimensionally molded casting foam component, to a method for manufacturing such a sanitary tub, and to a sanitary tub manufactured by the method.

### TECHNICAL BACKGROUND

Sanitary tubs, in the form of bathtubs and/or shower trays or washbasins, constitute a component of bathrooms. In addition, sanitary tubs are also used in medical care and rehabilitation facilities, therapeutic, thermal, and spa baths. Moreover, sanitary tubs are employed in the wellness and hotel sector, as well as in private environments, as whirlpools or tubs equipped with massage jets, and are available in various configurations, shapes, and sizes. In addition to sanitary tubs whose tub bodies are manufactured from ceramic, porcelain, plastic, or metal, sanitary tubs are also known whose tub body is formed from a structural foam and is provided with a stabilizing and sealing envelope. The tub body of such sanitary tubs is worked out, either entirely or in sections, from a massive block material by milling and cutting, and is subsequently provided with the envelope in further processing steps. In addition to the laborious and time-consuming manufacturing process, the considerable amount of waste material produced during machining of the block material is also disadvantageous.

In particular, in sanitary tubs designed as whirlpool tubs and equipped with a multitude of water-driven air and water jets, pump assemblies, filter units, as well as additional functional accessory parts such as lighting elements, sensors, or heating elements for creating a massage or wellness effect, additional technical challenges arise. The accessory parts mentioned, and the piping, hose line, and electrical routing systems required for them must, in conventional sanitary tubs, be subsequently installed into the pre-manufactured tub body. For this purpose, openings, recesses, or subsequent machining steps must be carried out on the tub body, which are laborious and can only be produced with the risk of leaky interfaces. In particular in the region of penetrations and connection points, potential leakage sites occur that are exposed during operation to hydrostatic water pressure and mechanical stresses and therefore often prove difficult to seal permanently and reliably.

In addition, the extensive piping that is unavoidable in whirlpool tubs is routed within an intermediate space between the tub body and the outer cladding that is usually inadequately thermally insulated. This results in significant heat losses through the piping systems to the surroundings and therefore in an increased heating demand, which adversely affects the energy balance of such sanitary tubs. Furthermore, leakage points in the foamed-in or confined intermediate space are often difficult to access, which complicates maintenance, repair, and hygienic cleaning.

This is a situation that needs to be improved.

### SUMMARY OF THE INVENTION

Against this background, the object of the present invention is to provide a device and a method for manufacturing a sanitary tub formed as a casting foam component, with reduced time and material requirements.

According to the invention, this object is achieved by a molding device having the features of claim 1, by a method having the features of claim 9, and/or by a sanitary tub having the features of claim 13.

The solution according to the invention provides a molding device for manufacturing a sanitary tub formed as a three-dimensionally molded casting foam component. The molding device has a cavity forming the negative mold of the sanitary tub and comprises a plurality of molding parts which can be connected to one another to close the molding device and which, in a connected state, form the cavity. At least one accessory part of the finished sanitary tub and/or at least one placeholder for at least one accessory part that is subsequently installable in the finished sanitary tub can be attached to at least one of the molding parts.

Furthermore, the solution according to the invention provides a method for manufacturing a sanitary tub formed as a casting foam component in a molding device according to the invention. The method comprises providing the molding parts in a non-connected state; applying a release agent to the inner surfaces of the molding parts that define the cavity; applying a first coating agent to the inner surfaces and curing the first coating agent; applying a second coating agent that overlies the first coating agent to the inner surfaces and curing the second coating agent; closing the molding device by pivoting or folding the molding parts to form the cavity and/or forming a plug-in, snap-in, clamping, or screw connection between the molding parts to form the cavity; filling the cavity with a flowable casting foam, in particular a two-component polyurethane liquid foam; and demolding the sanitary tub formed as a casting foam component after the casting foam has cured.

Furthermore, the solution according to the invention provides a sanitary tub manufactured in the method according to the invention. The sanitary tub has a tub body with a multilayer structure and comprises an inner tub core formed from a casting foam, a first layer surrounding the tub core, in particular formed from a polyurethane soft coating material, and a second layer applied to the first layer, in particular formed from an elastic polyurethane varnish. A sanitary tub within the meaning of the invention fundamentally denotes tubs, tub-shaped or tub-like vessels, basins, or the like for use in a sanitary environment, which comprise, among other things, an open, larger, deeper, and possibly elongated vessel, in particular for bathing, showering, or washing. A sanitary tub within the meaning of the invention thus includes, in particular, bathtubs, shower trays, whirlpools, foot bath tubs, arm bath tubs, sit bath tubs, medical and geriatric bathtubs, obstetric bathtubs, washbasins, and the like. Also encompassed are predominantly permanently installed basins or tubs that are used in kitchen environments, for example as sinks or washing tubs.

The idea underlying the present invention consists in dimensioning the cavity in a closable and openable molding device such that its volume corresponds to the volume of the finished casting foam component, thereby enabling the formation of the multilayer structure of the casting foam component within a single device. In this process, starting from the inner layering of the casting foam component, the multilayer structure can be built up step by step in the device. The build-up thus proceeds from the outside—i.e., beginning with the coating—towards the inside, i.e., towards the tub core that is introduced last and subsequently foamed. The construction of the molding device from multiple molding parts simplifies, in the non-closed state, the application of the outer layers of the casting foam component onto the molding parts, while connecting the already coated molding parts to close the molding device produces the cavity that forms the negative mold of the casting foam component. This cavity can then be easily filled with the casting foam in order to complete the casting foam component, i.e., the tub body in the manufacture of the sanitary tub. The coating forms the stabilizing outer shell or envelope of the casting foam component, which then only needs to be filled with the foam material. A further advantage is the stable and tight connection between the coating and the foamed filling material resulting from the manufacturing method. Moreover, the dimensioning of the cavity as well as the design of the molding parts enables accessory parts or placeholders provided for this purpose to be attached or molded in already at the factory before the cavity is filled with the casting foam. As a result, subsequent drilling or machining of the already finished tub body can be omitted, whereby potential leakage points can be reliably avoided. Furthermore, line routing associated with the accessory part, such as piping, hose lines, or power lines, can be embedded directly into the thermally insulating casting foam core during the foaming process. This leads to particularly advantageous thermal decoupling of the line systems from the surroundings, effectively reducing heat losses and enabling a reduced energy demand of the sanitary tub during operation. Overall, a fully functionally equipped multilayer tub body can thus be produced in a single, efficient manufacturing step, whereby the operational safety and energy efficiency of the manufactured sanitary tub can be sustainably improved. Moreover, after demolding, a casting foam component, in particular a sanitary tub, is thus provided which already comprises all coatings applied to the basic body formed from a foamed and cured foam material and, due to the coating structure, has a high component stability at low weight. The molding device enables the manufacture of sanitary tubs designed as casting foam components with reduced material and time expenditure, since the time-consuming and material-intensive machining of a massive material block with subsequent coating application is eliminated. The molding device also expands the scope for designing the respective casting foam component by allowing corresponding adaptation of the molding parts with respect to size, geometry, and selection and coloration of the coating material.

Advantageous embodiments and further developments arise from the further dependent claims as well as from the description with reference to the figures of the drawings.

According to a further development, it is provided that each molding part can be made available as a single part, wherein the cavity can be formed by combining several single parts, and wherein the single parts are connectable in particular via plug-in, snap-in, clamping, or screw connections in order to form the cavity.

By providing individually detachable and freely combinable single parts of the molding device, a particularly high degree of flexibility is achieved in designing the cavity. The molding device can be adapted to different geometric dimensions and contours depending on the desired embodiment of the sanitary tub, without the need to produce an entirely new, monolithic mold for this purpose. Instead, varying form complexities, tub interior contours, or functional regions can be represented by replacing or adding individual molding parts, which enables the manufacture of different sanitary tubs within a modular mold concept. This reduces manufacturing effort as well as tooling costs and offers a high variety of variants while at the same time shortening setup times.

In particular for sanitary tubs with complex interior geometry, such as whirlpool tubs, which often feature an individual arrangement of massage nozzles, seating or reclining surfaces, or ergonomic contours, the modular configuration of the molding parts permits easy adaptability to different functional layouts. User- or customer-specific configurations can thereby be implemented in a targeted manner through the selection of suitable single parts of the molding device, making different equipment variants feasible without fundamental tool modifications. Moreover, individual molding parts can be specifically designed for the integration of particular accessory regions, thereby ensuring a precise representation of the respective interior contour and the accessory positions in the sanitary tub to be manufactured. The modular construction of the molding device can lead to a high degree of design freedom, improved adaptability to different component embodiments, and a more efficient and economical production of sanitary tubs, in particular of whirlpool tubs with variable interior configurations.

According to a further development, the molding parts are connected to one another in a non-closed state of the molding device in a pivotable or foldable manner, in particular via hinges provided on adjacent outer edges. The hinges advantageously simplify the transition from the open to the closed state of the molding device by guiding the molding parts. The pivotable or foldable connection enables precise and repeatable closing of the molding device. This simplifies the production process and reduces the time required for assembling the molding device. The use of hinges ensures that the molding parts are joined together in the intended position during each production cycle. The pivotable or foldable mechanism facilitates access to the inner surfaces of the molding parts in the non-connected state, i.e., when the molding device is open. This enables uniform and controlled application of the coating materials to the cavity boundaries and ensures that the layers are applied cleanly and without interruptions. Since the hinges make the joining of the molding parts and the closing of the molding device efficient, the entire manufacturing process is accelerated. At the same time, they minimize the need for additional auxiliary means such as clamps or fasteners. The pivotable or foldable connection moreover allows easy adaptation of the molding parts, so that different sizes and geometries of the sanitary tub designed as a casting foam component can be realized. This considerably expands the range of applications of the device, in particular with regard to individual or complex shapes. The ability to close the molding parts quickly and precisely reduces the space requirements and the complexity of production lines and increases the efficiency in carrying out the work steps.

According to a further development further development, the molding parts have corresponding receptacles for connecting means that can be arranged in the connected state, in particular pins or screws. Advantageously, this achieves precise positioning of the molding parts relative to one another while simultaneously minimizing dimensional inaccuracies. By using pins or screws, a stable mechanical connection of the molding parts is achieved.

This prevents unintentional shifting or displacement of the parts during the manufacturing process, in particular during the filling of the casting foam. The stability directly affects the quality and dimensional accuracy of the sanitary tub produced or of the casting foam component forming it. The use of standardized connecting means such as pins or screws facilitates the repeated joining and separating of the molding parts. This is advantageous in particular in series production, since the connection can be established and released quickly and reliably. The corresponding receptacles and fixed connecting means also advantageously contribute to keeping the cavity sealed in the connected state and to preventing any escape of casting foam.

According to an alternative development, the molding parts have, on outer sides facing away from the cavity, corresponding plug-in, snap-in, or clamping means that interlock in the connected state. By using plug-in, snap-in, or clamping means, the joining process is significantly accelerated. In comparison with traditional connection methods such as screws or pins, no additional tools are required. This saves time and increases efficiency, particularly in series production. The interlocking connecting means enable tool-free joining of the molding parts. This facilitates handling for the operating personnel and simplifies the manufacturing process. The plug-in, snap-in, or clamping means ensure a firm mechanical connection of the molding parts in the connected state. This advantageously ensures a stable cavity that withstands the loads occurring during the filling and curing of the casting foam, without the molding parts shifting.

According to a further development, the cavity has a filling opening which is open in the connected state of the molding parts and can be closed by a separate molding part. The open filling opening advantageously enables simple filling of the flowable casting foam material. The separate molding part serves to securely and tightly close the cavity after filling, thereby ensuring a controlled foaming process. A further advantage is that air trapped during filling can easily escape through the open filling opening, reducing the risk of air inclusions in the foamed molded component. The separate molding part can be attached with temporal flexibility, allowing the foaming process to be optimally controlled. This enables adaptation to different geometries or sizes of the molded components. Since the separate molding part closes the cavity, it additionally contributes to the mechanical stability of the molding device, in particular during the curing of the foam material. This is particularly advantageous when high filling pressures occur. The separate molding part can be easily replaced or adapted to different geometries of the filling opening. This increases the flexibility of the device and enables adaptation to various production requirements. The separate molding part can furthermore be used to form or shape a terminating surface or a pedestal on the casting foam component or on the sanitary tub.

According to a further development, venting channels of the cavity are molded into the molding parts and/or into the separate molding part that closes the cavity. Advantageously, the venting channels integrated into the molding parts enable the controlled escape of trapped air during the filling of the cavity with the flowable casting foam. This prevents the formation of air inclusions that would impair the homogeneity and mechanical stability of the manufactured casting foam component. The venting channels also advantageously contribute to a uniform distribution of the casting foam material within the cavity. Through the controlled removal of air during the expansion of the foam material, the foaming process becomes more efficient, resulting in improved dimensional accuracy and surface quality of the sanitary tub or the casting foam component. The integration of the venting channels directly into the molding parts additionally eliminates the need to provide separate venting devices and advantageously reduces the complexity of the device. A further advantage is that the venting channels ensure controlled pressure relief during the filling and curing process and thereby reduce the risk that the molding parts are damaged by excessive internal pressure or that the cavity becomes leaky.

According to the invention, at least one accessory part of the finished sanitary tub designed as a casting foam component and/or at least one placeholder for an accessory part that is subsequently installable can be inserted into the molding parts. The possibility of inserting accessory parts such as drains, water inlets, nozzles, or other functional elements directly into the molding parts advantageously reduces the effort required for the subsequent installation of these components. This makes the production process more efficient and cost-effective. Placeholders in the molding parts, in contrast, ensure precise and reproducible positioning of the accessory parts in the sanitary tub or the casting foam component and advantageously improve the functionality and aesthetics of the final product, in particular in sanitary tubs with complex geometry. By using accessory parts or placeholders during the manufacturing process, subsequent operations such as drilling, milling, or other modifications to the finished component are also eliminated. The possibility of inserting placeholders for accessory parts that are to be installed later additionally allows greater flexibility in the design of the molding device and of the final product. Thus, different configurations for various applications can be realized more easily. The integration of accessory parts or placeholders during the foaming process advantageously ensures a seamless connection between these components and the foamed material. The tightness and stability of the finished casting foam component, in particular in sanitary tubs that are exposed to high loads or moisture, is thereby improved. In series production, this further development enables standardized and automated integration of accessory parts or placeholders, which advantageously increases production capacity and reduces the error rate.

According to a further development, it is provided that at least one piping, hose line, or power line connected to the accessory part or connectable to the accessory part that is subsequently installable in the finished sanitary tub can be attached to at least one of the molding parts. By factory-mounting line routings on at least one molding part, the pipe, hose, and/or cable connections required for the operation of the sanitary tub can already be specifically positioned during the molding process and subsequently embedded directly into the tub core to be foamed. This allows complete integration of the technical infrastructure into the multilayer tub body without the need for subsequent drilling, milling, or other machining of the tub body. In this way, potential leakage points at cutting or penetration regions are reliably avoided, and the tightness of areas later subjected to water or pressure loads during operation is sustainably increased. The lines arranged within the foam material furthermore experience comprehensive thermal enclosure, whereby undesirable heat transfer to the surroundings is effectively reduced. This has an energy-efficient effect particularly in applications with warm or temperature-controlled water and leads to a reduced heating demand during operation. A particular advantage arises in sanitary tubs designed as whirlpool tubs, in which a multitude of massage nozzles, air and water inlets, or lighting devices must be incorporated. The inventive integration of the associated line routings already in the molding device enables a precise, demand-oriented, and securely sealing arrangement of all functional components, as well as optimal thermal decoupling of the functional elements from the surroundings. At the same time, the installation and maintenance effort is significantly reduced, since the lines are routed within the finished tub body without confined intermediate spaces and without hard-to-access cavities. Thus, increased operational safety, extended service life, and a hygienically improved design of the sanitary tub can be achieved, while enabling economical manufacture even of complexly equipped whirlpool tubs with a high degree of functional integration.

According to a further development, it is provided that the at least one accessory part of the finished sanitary tub and/or the accessory part that is subsequently installable in the finished sanitary tub is designed as an air nozzle, water jet nozzle, lighting element, heating unit, circulation device, filter unit, air or water flow generator, skimmer, siphon, inlet, outlet, or nozzle connection, or as a connecting fitting. By providing a variety of different accessory parts, the functional scope of the sanitary tub can be expanded. The accessory parts can be integrated firmly into the multilayer tub body already during manufacturing, or alternatively can be subsequently installed in a sealing manner via corresponding placeholders. In this way, sanitary tubs can be equipped as needed without requiring extensive subsequent machining steps or penetrations of the tub body. This applies in particular to sanitary tubs designed as whirlpool tubs, in which several massage nozzles, air and water inlets, heating units, or lighting elements are regularly used in different arrangements. The ability to position and embed these functional components directly during molding improves both the tightness and the thermal efficiency of the respective installation parts, and thus contributes to increased operational safety and energy-efficient use of the sanitary tub.

The method according to the invention provides, in a further development, that before or after the step of applying a release agent, or before or after the step of applying a first coating agent to the inner surfaces and curing the first coating agent, attaching at least one accessory part of the finished sanitary tub or at least one placeholder that can be demolded from the finished sanitary tub for at least one accessory part that is subsequently installable in the finished sanitary tub and/or attaching piping, a hose line, or a power line connected to the accessory part or connected or connectable to the accessory part that is subsequently installable in the finished sanitary tub, as well as inlet, outlet, and/or nozzle connections, is carried out on at least one molding part.

By attaching the accessory parts or the associated line systems at this early stage, i.e., before foaming, precise positioning of the functional components in the finished tub body can be ensured. At the same time, the otherwise required subsequent opening, drilling, or machining of the outer or inner surfaces of the sanitary tub can be omitted, whereby potential leakages at penetration points are reliably avoided. The accessory parts or placeholders can thus already be fixed in a shape-and position-accurate manner when the foam material is introduced, which can result in a media-tight and pressure-tight foaming around the adjacent regions. The lines running within the foam core can be completely enclosed by thermally insulating material. As a result, heat losses during operation can be significantly reduced. This is particularly advantageous in a sanitary tub designed as a whirlpool tub, in which warm or temperature-controlled water is conducted continuously during operation and numerous line routings are present. Moreover, the installation of the technical equipment is reduced to a minimum, since it is already integrated during manufacturing and no hard-to-access intermediate spaces arise in which stagnant water or contaminants could accumulate.

The method according to the invention provides, in a further development, that after the step of closing the molding device, the molding parts are fixed by inserting the connecting means and/or by closing the interlocking plug-in, snap-in, or clamping means. Fixing the molding parts after closing the molding device advantageously ensures a stable and secure connection and prevents shifting or unintentional movement of the molding parts during the filling of the cavity and the curing of the casting foam. By fixing the molding parts, the molding device is maintained in its intended geometry, so that the cavity precisely reproduces the desired shape of the casting foam component. This contributes to a high repeat accuracy in manufacturing. The possibility of either using connecting means such as pins or screws and/or closing plug-in, snap-in, or clamping means allows flexible adaptation to different production requirements. This is particularly advantageous when the device is to be used for different casting foam components. Fixing the molding parts advantageously contributes to ensuring the tightness of the cavity and to preventing liquid casting foam from escaping during filling. The combination of closing the molding device and subsequently fixing it ensures intuitive and efficient handling, particularly in series production.

According to a further development, the method according to the invention provides, after forming the cavity, additionally coating the joints of the molding parts within the cavity with the first and/or second coating agent. The additional coating of the joints within the cavity ensures seamless formation of the coating, prevents the casting foam from penetrating into gaps or unintended areas, and contributes to a high sealing tightness of the cavity. The reworking of joints within the cavity advantageously ensures that the inner surfaces of the cavity have a smooth and uniform coating. This increases the quality of the outer surfaces of the sanitary tub manufactured as a casting foam component and reduces the need for reworking the final product.

According to a further development, the method according to the invention provides, after filling the cavity with a flowable casting foam, closing the filling opening of the cavity with the separate molding part. Closing the filling opening with the separate molding part advantageously prevents the flowable casting foam from escaping from the cavity. This reduces material losses and ensures efficient use of the foam material. By closing the filling opening, the cavity is furthermore completely sealed, whereby a uniform internal pressure is maintained during the curing of the foam material. This contributes to the dimensional accuracy and shape fidelity of the manufactured casting foam component. A further advantage is that closing the filling opening ensures controlled and homogeneous expansion of the foam material within the cavity and equalizes the foaming process.

According to a further development of the method according to the invention, the application of the first and/or second coating agent is carried out in a hot-spray process, the first coating agent being formed in particular as an elastic polyurethane varnish and/or the second coating agent being formed as a polyurethane soft-coating material. By applying a hot-spray process, a uniform distribution of the coating material on the inner surfaces of the cavity is advantageously achieved, thereby improving the surface quality of the finished component. By heating the coating material in the hot-spray process, its viscosity is reduced and its flow behavior is improved. An advantage of this is that a uniform surface structure is achieved and the adhesion of the coating materials is improved. The hot-spray process advantageously accelerates the chemical reaction processes of the coating materials and thereby reduces production times. By controlling the temperature and spray parameters, the hot-spray process can furthermore be adapted to different material properties. A hot-spray process within the meaning of the present invention is understood to be an application process in which coating materials, for example polyurethane varnishes or polyurethane soft-coating materials, are heated in a reactor to the required processing temperature (typically 60-90° C.). The heated material is then applied to the inner surfaces of the cavity via a nozzle under high pressure in a finely atomized spray jet. Polyurethane varnishes are applied, for example, as thin, in particular—depending on the application—between 1 mm and 10 mm, especially between 2 mm and 5 mm, preferably 3 mm thick, elastic protective and top layers, which cure quickly and form a robust, smooth surface. Polyurethane soft-coating materials, in contrast, are applied in thicker layers in order to produce a flexible, impact-absorbing, and insulating layer. The method advantageously ensures efficient coating with a uniform, defined layer thickness in each case and with high adhesion of the coating materials.

According to an embodiment of the method according to the invention, the first coating agent may be formed as an elastic polyurethane varnish. Elastic polyurethane varnishes are characterized by high elasticity and resilience. They absorb mechanical loads, thereby preventing cracks or chipping of the coating. Advantageously, this increases the service life and durability of the molded component. A further advantage is that the polyurethane varnish forms a protective top layer that protects the finished molded component from moisture, chemical influences, UV radiation, and mechanical abrasion. This is particularly advantageous for sanitary tubs that are used in humid environments and are subject to frequent use. An elastic polyurethane varnish not only ensures functional protection but also allows individual coloration of the molded component by adding appropriate color pigments. Various elastic polyurethane varnishes are suitable for use in the method according to the invention, including, for example, 1-component polyurethane varnishes, 2-component polyurethane varnishes, water-based polyurethane varnishes, or solvent-based polyurethane varnishes, without limiting the invention thereto.

According to an embodiment of the method according to the invention, the second coating agent may be formed as a polyurethane soft-coating material. Polyurethane soft-coating materials are characterized by high elasticity and impact-absorbing properties. Advantageously, the coating of polyurethane soft-coating material that lies directly on the foam body protects the molded component from mechanical loads. The material furthermore forms a soft, uniform, and tactile surface. Various types of polyurethane soft-coating materials are suitable for use in the method according to the invention, including, for example, 2-component polyurethane soft coatings consisting of two components (polyol and isocyanate), solvent-free polyurethane coatings, UV-resistant polyurethane soft coatings, or hot-sprayable polyurethane soft coatings, without limiting the invention thereto. Advantageously, the material thickness of the polyurethane soft coating can be flexibly adapted according to the requirements of the casting foam component in order to meet different load or insulation requirements.

According to a further development of the method according to the invention, the flowable foam material is formed as a two-component polyurethane liquid foam (2K PU foam). Two-component polyurethane liquid foam advantageously enables simple and controllable processing. The foam material is processed in a liquid state, allowing precise filling of the cavity even in the case of complex geometries. After the chemical reaction and curing, the two-component polyurethane liquid foam forms a solid foam body with high dimensional stability and mechanical strength, and is therefore particularly advantageous for the manufacture of sanitary tubs. A further advantage is that the properties of the foam material, in particular with respect to density, compressive hardness, and specific weight, can be variably adjusted by adapting the mixing ratios of the two components, polyol and isocyanate, in order to meet the requirements of specific casting foam components. A two-component polyurethane liquid foam (2K PU foam) within the meaning of the present invention is understood to be a two-component polyurethane liquid foam that consists of two chemical main components, i.e., polyol (component 1), an alcohol-based substance that serves as the base material, and isocyanate (component 2), which reacts chemically with the polyol in an exothermic reaction and, through the formation of gases, leads to the formation of foam. The two components are combined and homogenously mixed in a defined ratio in a mixing head or a special mixing device. The reaction leads to the expansion and solidification of the foam material, which, immediately after mixing and during the open time of the mixture, spreads in its still-liquid state within the cavity and cures after foaming. Various types of two-component polyurethane liquid foams are suitable for use in the method according to the invention, including, for example, high-density PU foams, low-density PU foams, open-cell PU foams, or closed-cell PU foams, without, however, limiting the invention thereto. In addition to the two-component polyurethane liquid foam described above, the following materials are alternatively encompassed by the present invention and can be used according to the invention: one-component polyurethane foam, epoxy resin-based foams, polyethylene foam, or phenolic resin foam.

The sanitary tub according to the invention provides, in a further development, that it is designed as a bathtub, washbasin, shower tray, shower pan, or whirlpool tub. By using materials such as a dimensionally stable casting foam and polyurethane coatings, the sanitary tub is significantly lighter than conventional tubs made of ceramic or metal. This advantageously simplifies transport, installation, and handling, particularly in the case of large-format tubs such as bathtubs or whirlpools. The method according to the invention advantageously enables free design of the tub shape. As a result, complex geometries, ergonomic designs, or special adaptations for individual customer requirements can be realized. This is particularly advantageous for modern bathroom designs or special applications in the medical or wellness sector. The combination of a lightweight core material and durable coatings advantageously ensures that the tubs are long-lasting and easy to maintain even under intensive use. A sanitary tub within the meaning of the invention fundamentally denotes tubs, tub-shaped or tub-like vessels, basins, or the like for use in a sanitary environment, which comprise, among other things, an open, larger, deeper, and possibly elongated vessel, in particular for bathing, showering, or washing. A sanitary tub within the meaning of the invention thus includes, in particular, bathtubs, shower trays, whirlpools, foot bath tubs, arm bath tubs, sit bath tubs, medical and geriatric bathtubs, obstetric bathtubs, washbasins, and the like. Also encompassed are predominantly permanently installed basins or tubs that are used in kitchen environments, for example as sinks or washing basins. The sanitary tub according to the invention provides, in a further development, that at least one accessory part, at least one demoldable placeholder for at least one accessory part that is subsequently installable in the finished sanitary tub, and/or piping, a hose line, or a power line connected to the at least one accessory part or connected or connectable to the at least one accessory part that is subsequently installable in the finished sanitary tub, as well as in particular inlet, outlet, or nozzle connections, can be molded into the sanitary tub during manufacture.

By molding the accessory parts or the associated line systems already during manufacture, complete functional integration into the multilayer tub body is achieved. The components are integrally embedded in the foam core in an exact position, without requiring subsequent processing steps such as drilling, milling, or sealing of penetrations. This results in permanently high leak-tightness during operation and reduces susceptibility to leakages or design-related weak points.

The lines running within the foam material undergo full-surface thermal insulation, thereby minimizing heat losses and significantly reducing the energy expenditure required to operate the water contained in the sanitary tub. In addition, the interior of the sanitary tub is kept free of hard-to-access intermediate spaces, which creates a hygienically advantageous design and facilitates cleaning and maintenance operations.

A particular field of application of this further development is sanitary tubs designed as whirlpool tubs, in which a multitude of different functional components such as massage nozzles, lighting elements, sensors, or heating units may be provided in various spatial arrangements. The inventive molding-in allows precise and layout-flexible positioning of such functional units in the tub body and thereby supports a diverse design of different whirlpool configurations without requiring different basic bodies to be manufactured.

In addition to inlet, outlet, and nozzle connections, further accessory parts can also be integrated into the tub, such as, for example, without limiting the invention thereto, overflows; sensor connections, in particular for controlling temperature, fill level, or water quality, preferably in whirlpools; heating elements for directly heating the water in the tub; LED lighting elements; massage nozzles, in particular for water or air massage in whirlpools or wellness tubs; grab handles and fittings; loudspeakers or sound modules, in particular for integrating audio systems into wellness or luxury tubs. The seamless integration of accessory parts advantageously reduces the number of joints and transitions that represent potential weak points for wear or leakage.

In an alternative further development, the sanitary tub according to the invention provides that the tub body comprises demoldable placeholders for arranging accessory parts. The demoldable placeholders advantageously ensure that accessory parts such as connectors or fittings can be inserted into the tub body precisely and easily during final assembly. The use of placeholders also facilitates the subsequent installation of accessory parts, since these can be retrofit as needed or upon customer request even after the sanitary tub has been manufactured, without the need for extensive reworking. Advantageously, the placeholders also permit a high degree of flexibility in equipping the sanitary tub with accessory parts, which can be individually adapted to different applications or user requirements.

In addition to the aforementioned inlet, outlet, or nozzle connections, placeholders can be molded in, for example, for the following accessory parts—without limiting the invention thereto—which may also be retrofittable: mounting brackets for water taps or mixer faucets, grab handles, soap or shampoo trays, sensor connections for, for example, fill-level sensors, temperature sensors, or other control elements, loudspeakers or audio connections, LED lighting installations, whirlpool systems such as air or water jet nozzles and air inlets, water filtration or disinfection systems, or aromatherapy units. Advantageously, placeholders minimize the need for subsequent drilling or milling of the tub body and ensure that a consistently smooth surface of the sanitary tub is preserved when accessory parts are retrofitted.

The above embodiments and further developments may be combined with one another in any desired manner, insofar as this is appropriate. Further possible embodiments, further developments, and implementations of the invention also include combinations—not explicitly mentioned—of features of the invention described above or below with respect of the exemplary embodiments. In particular, the person skilled in the art will also add individual aspects as improvements or supplements of the respective basic form of the present invention.

### DESCRIPTION OF THE DRAWINGS

The present invention will be explained in more detail below with reference to the exemplary embodiments indicated in the schematic figures of the drawings. In the drawings:

FIG. 1 shows a perspective view of the molding device according to an embodiment of the invention in an open state;

FIG. 2 shows a perspective view of the molding device according to an embodiment of the invention in a closed state;

FIG. 3 shows a perspective view of a sanitary tub according to an embodiment of the invention;

FIG. 4 shows a schematic cross-sectional view of a tub body of a sanitary tub according to an embodiment of the invention;

FIG. 5 shows a schematic flow diagram of a method according of the invention for manufacturing the sanitary tub of FIG. 3 according to a further embodiment of the invention;

FIG. 6a-c show perspective views of individual molding parts of the molding device according to an embodiment of the invention in a non-connected state;

FIG. 7 shows a perspective view of a molding part of the molding device according to an embodiment of the invention;

FIG. 8 shows a perspective view of a molding part of the molding device according to an embodiment of the invention;

FIG. 9 shows a perspective view of a molding part of the molding device according to an embodiment of the invention; and

FIG. 10 shows a perspective view of a sanitary tub according to an embodiment of the invention.

The accompanying figures of the drawings are intended to provide a further understanding of the embodiments of the invention. They illustrate embodiments and, in conjunction with the description, serve to explain principles and concepts of the invention. Other embodiments and many of the advantages mentioned become apparent with reference to the drawings. The elements of the drawings are not necessarily shown to scale relative to one another.

In the figures of the drawings, identical, functionally identical, and identically acting elements, features, and components are—unless stated otherwise—identified by the same reference numerals.

### DESCRIPTION OF EXEMPLARY EMBODIMENTS

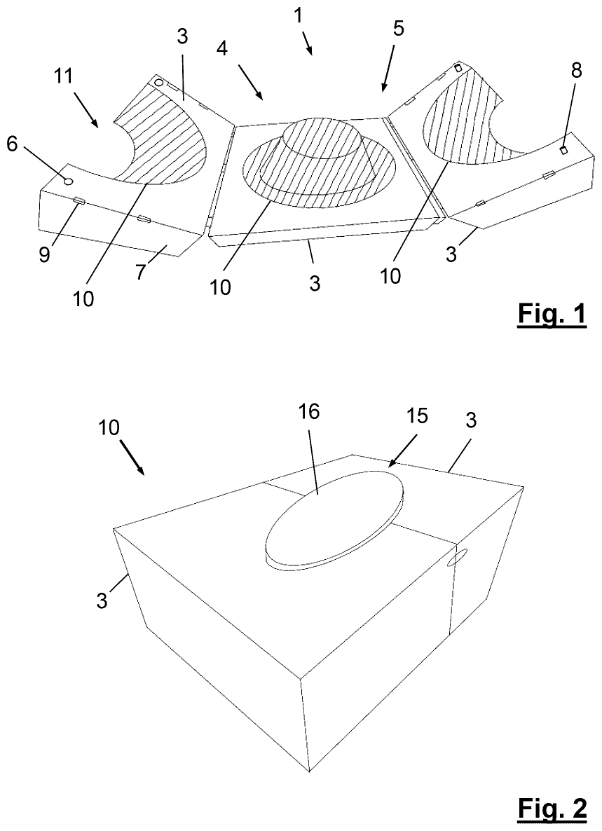

FIG. 1 shows a perspective view of a molding device 1 according to an embodiment of the invention in the open state. The molding device 1 serves to form a sanitary tub 2, for example a bathtub, shower tray, or whirlpool tub, from a casting foam. The molding device 1 comprises several interconnected molding parts 3 which, in the closed state, form a negative mold 4 with a cavity 5 that defines the three-dimensional outer contour of the sanitary tub 2. The illustrated molding parts 3 have corresponding receptacles 6 for connecting means 8, in particular pins or screws, in order to fix the molding parts 3 in the closed state of the molding device 1. In addition, corresponding interlocking clamping means 9 are provided on the outer sides 7 of the molding parts 3 facing away from the cavity 5, which enable additional stabilization and easy closing of the molding device 1. On the inner surfaces 10 of the molding parts 3, which in the closed state (see FIG. 2) define and delimit the cavity 5 located inside 11 the molding device 1 after closing, a residue-free release agent is first applied in order to facilitate later demolding of the sanitary tub 2. Subsequently, the first coating agent, preferably an elastic polyurethane varnish forming a flexible outer layer 18 of the sanitary tub 2, is applied. Thereafter, the second coating agent, a polyurethane soft-coating material, is applied, which has an impact-absorbing effect and forms an intermediate layer 19 located between the outer layer 18 and the tub core 14. Both coating agents are applied by means of a hot-spray process, thereby ensuring uniform material distribution and optimal adhesion. After completion of the coating application, the molding parts 3 are pivoted or folded in in order to bring the molding device 1 into the closed state (see FIG. 2). In doing so, the connecting means 8 inserted into the receptacles 6 of the molding parts 3 and the clamping means 9 provided on the outer sides 7 of the molding parts 3 are used to connect the individual molding parts 3 to one another and to close the molding device 1. As a result, the cavity 5 inside 11 the molding device 1 is fully formed and prepared for receiving the flowable casting foam material, preferably a two-component polyurethane liquid foam, which forms the tub core 14 of the sanitary tub 2 to be manufactured.

FIG. 2 shows a perspective view of the molding device 1 according to an embodiment of the invention in the closed state. The molding device 1 shown in the exemplary embodiment serves to form a sanitary tub 2, for example a bathtub, shower tray, or whirlpool tub. The molding device 1 consists of several molding parts 3 shown connected in FIG. 2, which in the closed state form a negative mold 4, not visible in FIG. 2, in a cavity 5 that defines the three-dimensional contour of the sanitary tub 2 to be manufactured.

After closing the molding device 1, the cavity 5 is filled with a flowable two-component polyurethane liquid foam. For this purpose, the flowable foam material is introduced into the cavity 5 through the filling opening 15 provided on the upper side of the molding device 1 and distributes uniformly within the cavity 5. Venting channels (not shown), which are integrated into the molding parts 3, enable the controlled escape of trapped air, whereby a homogeneous and dimensionally stable foam body is formed as the tub core 14. Immediately after filling, the filling opening 15 is closed with a separate molding part 16 in order to completely seal the cavity 5. After the end of the so-called open time, the foaming process begins, during which the foam material expands and completely fills the cavity 5. After the foam material has cured, the molding device 1 is opened in order to demold the finished sanitary tub 2.

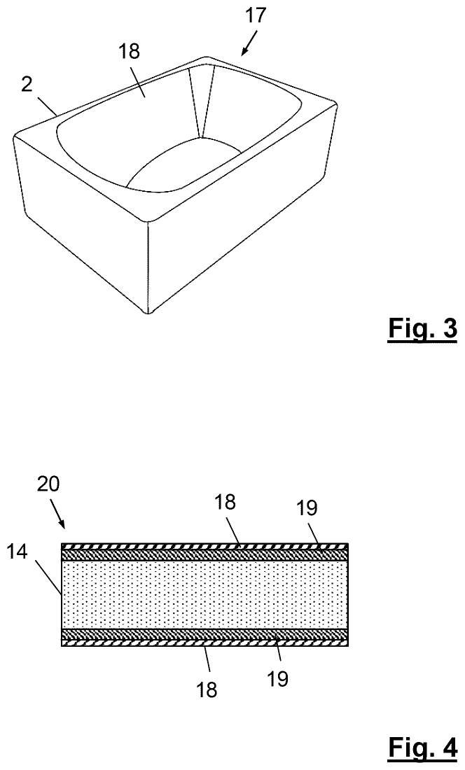

FIG. 3 shows a perspective view of a sanitary tub 2 according to an embodiment of the invention. The illustrated sanitary tub 2 is the result of the method according to the invention and has a multilayer structure that offers both functional and aesthetic advantages. The surface 17 of the sanitary tub 2 is defined by a smooth and durable outer layer 18, which is formed from an elastic polyurethane varnish. This outer layer 18 forms the protective and flexible surface 17 of the sanitary tub 2. Not visible in FIG. 3 is an intermediate layer 19 arranged beneath the outer layer 18 of the sanitary tub 2, which is formed from a polyurethane soft-coating material and lies directly on the tub core 14.

The tub core 14 of the sanitary tub 2, which in the exemplary embodiment is covered by the layers 18, 19 and therefore not visible, is made of a dimensionally stable, cured two-component polyurethane liquid foam, which was formed after producing the layers 18, 19 in the open molding device 1 by casting the closed molding device 1 with a two-component polyurethane liquid foam.

FIG. 4 shows a schematic cross-sectional view of a tub body 20 of a sanitary tub 2 according to an embodiment of the invention. The tub body 20 has a multilayer structure and is manufactured in the molding device 1 shown in FIGS. 1 and 2 using the method described above. The structure is formed from the outside, i.e., starting from the outer layer 18 toward the inside, i.e., toward the foamed tub core 14. First, the first, outer layer 18 is formed by applying an elastic polyurethane varnish, for example in a hot-spray process, to the molding parts 3. After curing of the outer layer 18, a second intermediate layer 19 formed from a polyurethane soft-coating material is applied directly onto it, for example likewise in a hot-spray process. After complete curing of the two layers 18, 19, these form a shell or outer casing lining the cavity 5 in the closed molding device 1, which is cast with a flowable two-component polyurethane liquid foam (2K PU foam) in order to form the tub core 14 after foaming and curing. For coloring the sanitary tub 2, the polyurethane varnish may be provided with color pigments.

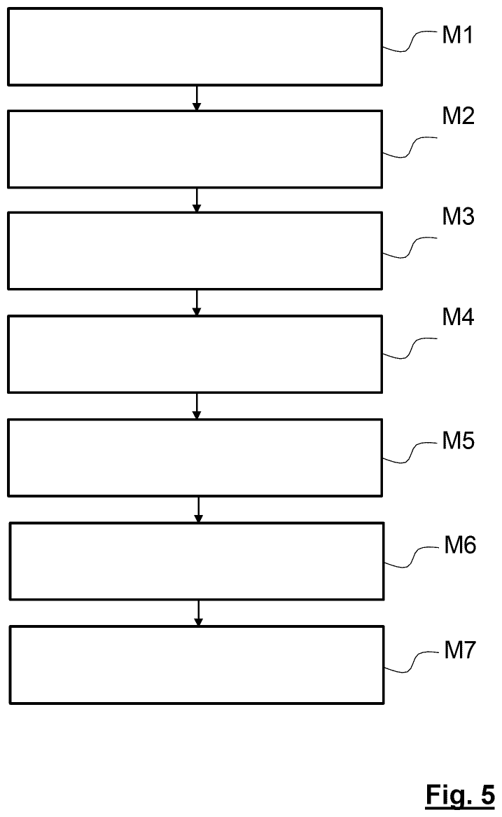

FIG. 5 shows a schematic flow diagram of a method according to the invention for manufacturing the sanitary tub 2 of FIG. 3 according to an embodiment of the invention. In the method, in a first step M1, an open molding device 1 formed from a plurality of molding parts 3 defining a cavity 5 is provided, the molding parts 3 being in an unconnected state. In the subsequent step M2, a release agent is applied to the inner surfaces 10 of the molding parts 3 that delimit the cavity 5. Thereafter, in step M3, a polyurethane varnish as the first coating agent is applied to the inner surfaces 10 of the molding parts 3, where it cures to form the outer layer 18 of the finished sanitary tub 2. In the subsequent step M4, a polyurethane soft-coating material is applied as the second coating agent directly onto the cured first coating agent. The application of the second coating agent is carried out in such a way that it completely covers the first coating agent. After curing of the second coating agent, the molding device 1 is closed in step M5 by pivoting or folding the molding parts 3 or by forming a plug-in, snap-in, clamping, or screw connection between the molding parts 3, whereby the cavity 5 is formed inside 11 the molding device 1. In the subsequent step M6, the cavity 5 is filled with a flowable casting foam, in particular a two-component polyurethane liquid foam (2K PU foam), in order to form the tub core 14. After curing, the finished sanitary tub 2 designed as a casting foam component is demolded in step M7 after opening the molding device 1. Optionally, before or after step M2 of applying a release agent, or before or after the step of applying a first coating agent to the inner surfaces 10 and curing the first coating agent, attaching at least one accessory part 21 of the finished sanitary tub 2 or at least one placeholder 22 that can be demolded from the finished sanitary tub 2 for at least one accessory part 21 that is subsequently installable in the finished sanitary tub 2, and/or attaching piping 23, a hose line or a power line connected to the accessory part 21 or connected or connectable to the accessory part 21 that is subsequently installable in the finished sanitary tub 2, as well as inlet, outlet and/or nozzle connections, is carried out on at least one molding part 3.

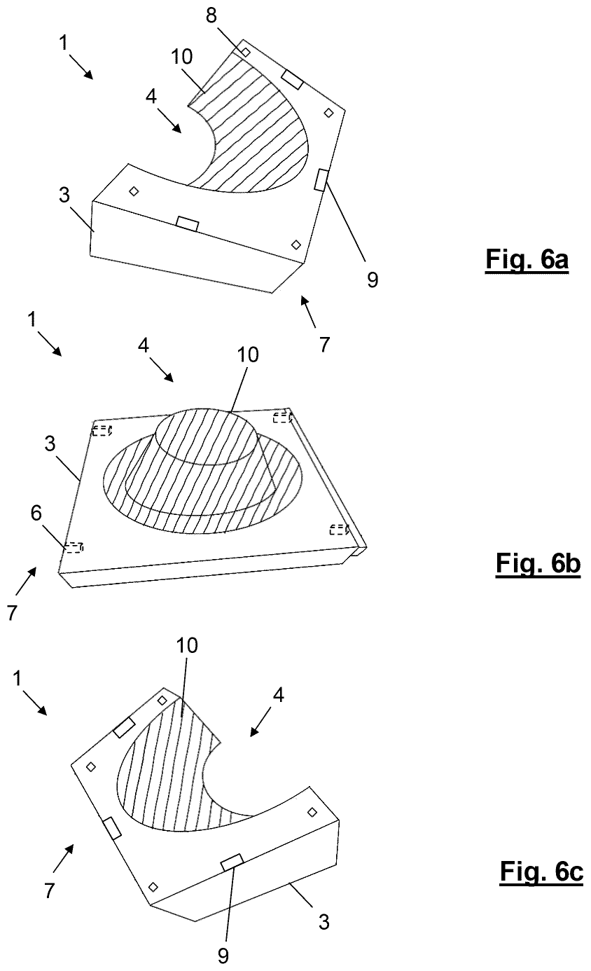

FIG. 6a shows a perspective view of a first molding part 3 of the molding device 1 in the unconnected state. The molding part has a negative mold 4 formed on the inner surface 10, receptacles 6, as well as connecting means 8 and clamping means 9 arranged on the outer side 7, which enable detachable connection to further molding parts.

FIG. 6b shows a perspective view of a second molding part 3 of the molding device 1 in the unconnected state, with a negative mold 4 formed on the inner surface 10 that differs in configuration from that of the first molding part, as well as receptacles 6 provided on the outer side 7. This molding part can be combined with various other molding parts for variably forming the interior of the tub.

FIG. 6c shows a perspective view of a third molding part 3 of the molding device 1 in the unconnected state, which has a curved configuration of the negative mold 4 on the inner surface 10 and is provided with clamping means 9 on the outer side 7 in order to contribute, in a connected state, to forming an individually designable cavity 5.

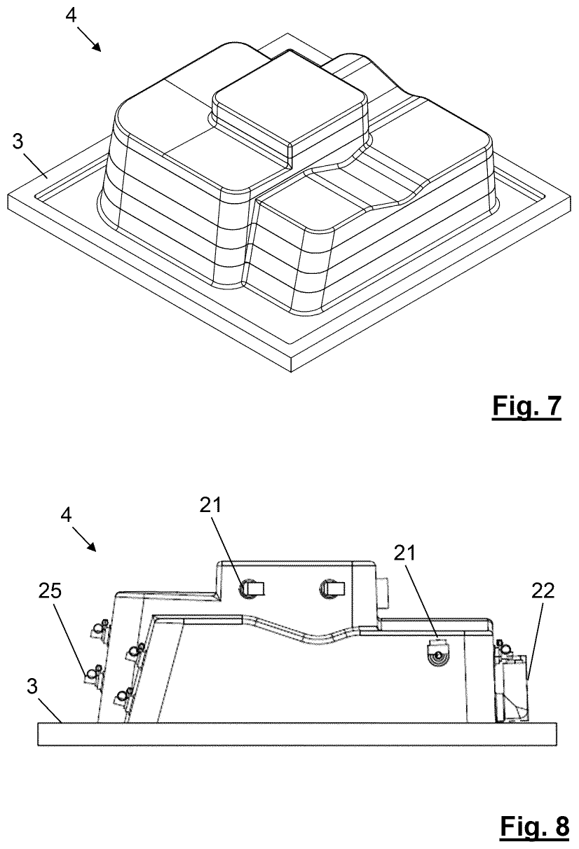

FIG. 7 shows a perspective view of a molding part 3 of the molding device 1, which has a negative mold 4 with multiple stepped and contoured regions formed on the inner surface. The illustrated molding part 3 is provided in particular for manufacturing a sanitary tub 2 designed as a whirlpool 27, in which different ergonomic functional areas such as sitting and reclining zones as well as locally recessed sections are formed. Due to the modular structure of the molding device 1, such a complex interior geometry of the sanitary tub 2 can be represented in the negative mold 4 of the respective molding part 3 and can thereby be flexibly adapted to different whirlpool configurations.

FIG. 8 shows a perspective view of a molding part 3 of the molding device 1, in which various accessory parts 21 as well as a placeholder 22 are already arranged on the negative mold 4 formed on the inner surface. The accessory parts illustrated here by way of example may serve for forming air or water nozzles 25, lighting devices, or further functional components as are provided in particular in a sanitary tub 2 designed as a whirlpool. The shown placeholder 22 enables the formation of an installation space in the later tub body 20, in which, for example, a heating or circulation device can be arranged after completion of the molding process.

By directly arranging the accessory parts or the placeholders provided therefor on the molding part, their positionally and functionally correct integration takes place already during the molding process. This avoids any subsequent opening or machining of the sanitary tub 2, while at the same time the technical devices required in particular for whirlpool applications are fixed in an application-optimized position within the tub body 20.

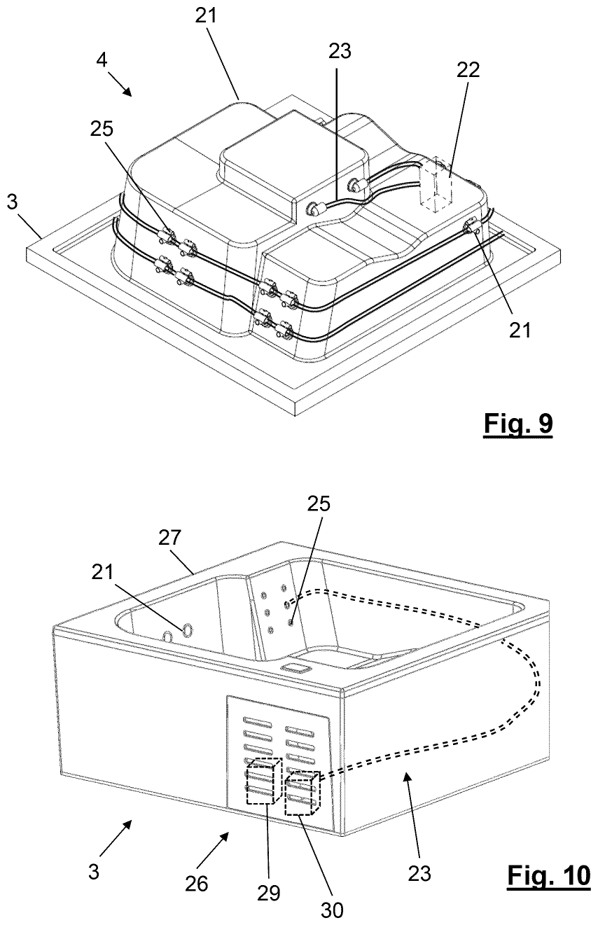

FIG. 9 shows a perspective view of a molding part 3 of the molding device 1, in which several accessory parts 21, for example air or water nozzles 25, are provided in a functionally correct position on the negative mold 4 formed on the inner surface. These accessory parts 21 are connected to one another via piping 23, which is routed along the contours of the molding part 3. In addition, a placeholder 22 is arranged, in which functional devices such as, for example, a circulation or heating device can be accommodated after completion of the molding process.

The piping 23 is designed such that it is completely enclosed by the foaming material during the foaming of the tub body 20. As a result, a permanently protected and thermally insulated line routing is created within the later foam material. This provides the possibility of pre-positioning all line and connection structures required for the functionality of a sanitary tub 2, in particular one designed as a whirlpool 27, already during molding and integrating them into the tub body 20 without subsequent machining steps. In this way, a leak-tight, thermally optimized, and low-assembly configuration of the tub body 20 can be achieved, the position of the accessory parts 21 and the piping 23 connected thereto being precisely predetermined by the negative mold 4. At the same time, a defined receiving space 26 for additional technical components can be created in the region of the placeholder 22, so that different whirlpool variants with varying functional equipment can be realized by replacing or supplementing accessory parts 21 and line elements.

FIG. 10 shows a perspective view of a sanitary tub 2 designed as a whirlpool according to an embodiment of the invention. In the sanitary tub 2 shown, several accessory parts 21, such as air nozzles 25 or water nozzles, are arranged in different functional zones of the inner contour. These accessory parts 21 are connected to each other via piping 23 running within the tub body 20, which is embedded into the foam material during foaming and is thus permanently protected and thermally insulated within the multilayer structure. On the outer side of the sanitary tub 2, a receiving space 26 is arranged, which can be formed by a placeholder 22 integrated into the negative contour. Functional devices such as, for example, a filter unit 29 and/or an air or water flow generator 30 can be accommodated in the receiving space 26. Via the piping 23 integrated into the tub body 20, the necessary fluid connections to the nozzles and other installations provided in the interior are established. This design enables completion of all installation and connection work required in particular for whirlpool operation already during the manufacturing process, so that subsequent penetrations or machining steps on the tub body 20 are eliminated.

The integrative design provides a whirlpool tub equipped ready for operation with a high degree of operational reliability, reduced energy demand, and flexible adaptability of the equipment to different requirements and configuration variants.

Although the present invention has been fully described above with reference to preferred embodiments, it is not limited thereto but can be modified in many different ways.

### LIST OF REFERENCE NUMERALS

1 molding device
2 sanitary tub
3 molding part
4 negative mold
5 cavity
6 receptacle
7 outer side
8 connecting means
9 clamping means
10 inner surface
11 interior
14 tub core
15 filling opening
16 separate molding part
17 surface
18 outer layer
19 intermediate layer
20 tub body
21 accessory part
22 placeholder
23 piping
25 air nozzle
26 receiving space
27 whirlpool
29 filter unit
30 air or water flow generator
M1-M7 method steps

1. Molding device for manufacturing a sanitary tub formed as a three-dimensionally molded casting foam component, with a cavity forming a negative mold of the sanitary tub, comprising a plurality of molding parts which can be connected to each other to close the molding device and which, in a connected state, form the cavity, wherein at least one accessory part of the finished sanitary tub and/or at least one placeholder for at least one accessory part subsequently installable in the finished sanitary tub can be attached to at least one of the molding parts.

2. Molding device according to claim 1, characterized in that each molding part is provided as a single part, wherein the cavity can be formed by combining several single parts and wherein the single parts can be connected in particular by means of plug-in, snap-in, clamp, or screw connections in order to form the cavity.

3. Molding device according to claim 1, characterized in that the molding parts are connected or connectable to each other in a non-closed state of the molding device in a pivotable or foldable manner, in particular via hinges provided on adjacent outer edges.

4. Molding device according to claim 1, characterized in that the molding parts have corresponding receptacles for connecting means that can be arranged in the connected state, in particular pins or screws, and/or have, on outer sides facing away from the cavity, corresponding plug-in, snap-in, or clamping means, which interlock in the connected state.

5. Molding device according to claim 1, characterized in that venting channels of the cavity are formed into the molding parts.

6. Molding device according to claim 1, characterized in that the cavity comprises a filling opening open in the connected state of the molding parts and closable by a separate shaping part, in particular wherein venting channels of the cavity are provided, which are molded into the separate shaping part.

7. Molding device according to claim 1, characterized in that at least one piping, hose line or powerline connected with the accessory part or connectable to the accessory part subsequently installable in the finished sanitary tub can be attached to at least one of the molding parts.

8. Molding device according to claim 1, characterized in that the at least one accessory part of the finished sanitary tub and/or the accessory part subsequently installable in the finished sanitary tub is configured as an air nozzle, water jet nozzle, light element, heating unit, circulation device, filter device, air or water flow generator, skimmer, siphon, inlet, outlet or nozzle connection, or connection fitting.

9. Method for manufacturing a sanitary tub configured as a molded casting foam component in a molding device according to claim 1, comprising the steps of:
providing the molding parts in a non-connected state;
applying a release agent to the inner surfaces of the molding parts delimiting the cavity;
applying a first coating agent to the inner surfaces and curing the first coating agent;
applying a second coating agent, overlaying the first coating agent, to the inner surfaces and curing the second coating agent;
closing the molding device by pivoting or folding the molding parts and/or forming a plug-in, snap-in, clamp, or screw connection between the molding parts to form the cavity;
filling the cavity with a flowable casting foam, in particular a two-component polyurethane liquid foam; and
unmolding the sanitary tub after the casting foam has cured.

10. Method according to claim 9, characterized in that, before or after the step of applying a release agent or before or after the step of applying a first coating agent to the inner surfaces and curing the first coating agent, at least one accessory part of the finished sanitary tub or at least one placeholder, removable from the finished sanitary tub, for at least one accessory part subsequently installable in the finished sanitary tub and/or of a piping, hose line or power line connected to the accessory part or connectable to the accessory part subsequently installable in the sanitary tub as well as inlet, outlet and/or nozzle connections are attached to at least one molding part.

11. Method according to claim 9, characterized in that after filling the cavity with the flowable casting foam, the filling opening of the cavity is closed with the separate molding part.

12. Method according to claim 9, characterized in that the first and/or second coating agent is applied in a hot spraying process, wherein the first coating agent is configured in particular as an elastic polyurethane varnish and/or the second coating agent is configured as a polyurethane soft coating material.

13. Sanitary tub manufactured by a method according to claim 9, wherein the tub body has a multi-layer configuration comprising an inner tub core formed from a cured casting foam, an intermediate layer in particular formed from a polyurethane soft coating material and enclosing the tub core, and an outer layer applied to the intermediate layer and in particular formed from an elastic polyurethane varnish.

14. Sanitary tub according to claim 13, characterized in that the sanitary tub is configured as a bathtub, washbasin, shower tray, shower pan or whirlpool tub.

15. Sanitary tub according to claim 13, characterized in that at least one accessory part, at least one removable placeholder for at least one accessory part installable subsequently in the finished sanitary tub and/or at least one piping, hose line or powerline connected to the accessory part or connectable to the accessory part subsequently installable in the sanitary tub and/or inlet, outlet and/or nozzle connections can be molded into the sanitary tub.
